(19) United States
(12) Patent Application Publication
(10) Pub. No.: US 2026/0251503 A1
(43) Pub. Date: Aug. 27, 2026

(54) METHOD FOR CLASSIFYING A COLOR OF A MAKEUP PRODUCT AND TOOL FOR ASSISTANCE IN THE DEVELOPMENT OF COLORS OF MAKEUP PRODUCTS

(71) Applicant: L'Oreal, Paris (FR)

(72) Inventors: Haiting GU, Shanghai (CN); Alexander M. Jaspers, Kanagawa (JP); Theo M. Phan Van Song, Chevilly La Rue (FR); Yue Qiao, Chevilly La Rue (FR)

(73) Assignee: L'Oreal, Paris (FR)

(21) Appl. No.: 18/877,436

(22) PCT Filed: Jun. 21, 2022
(86) PCT No.: PCT/CN2022/100042

§ 371 Date: Dec. 20, 2024

(51) Int. Cl. G01J 3/46; G01J 3/52

(52) U.S. Cl. CPC G01J 3/462; G01J 3/463; G01J 3/522; G01J 2003/466

(57) ABSTRACT

The computer implemented tool, intended to be controlled by a user, for assistance in the development of colors of makeup products, comprises: a mapping mode adapted for the user to select a group of colors of makeup products from a makeup product color bank, configured to classify each color of the selected group of colors with the method for classifying a color of a makeup product according to a labels designed according to a subjective perception of makeup colors. The mapping mode being configured to display a map of the selected colors arranged in a table according to the respectively assigned labels, the table being organized by a major line for each color family labels, and a major column for each hue tone subfamily labels, each major line including a subline for each lightness subfamily labels, each major column including a subcolumn for each chroma subfamily labels.

Embodiments of the invention are related to a method for classifying a color of a cometic makeup product, which is automatically implemented by a computer, and a tool for assistance in the development of colors of cosmetic makeup products, which is implemented by a computer and controlled by a user.

By “cosmetic product” is meant any product as defined in Regulation (EC) No. 1223/2009 of the European Parliament and of the Council of Nov. 30, 2009, concerning cosmetic products. A cosmetic make-up product, or “makeup product” is more particularly intended to cover a body surface in order to modify the perceived color and/or texture.

The development of colors of makeup products can comprise visualization and comparison of colors of makeup products existing in a given market, and for different skin tones, for instance in order to identify trends on customer's preferred color shades, or to identify which color shades could be missing and needed in the given market.

For example, the studied markets can vary from the low-cost products to luxury products, and the products can vary according to the market location, such as for example the Asian or Chinese market different than the European market.

Comparison between makeup products can be made between products of different brands and franchise of a same company, or between owned legacy products and a competitor's products.

The visualization is typically made by color experts with physical samples of the colors under human eye perception, for instance with thumbnails color samples of the makeup products, because of the great reaction in the subjective perception of the makeup colors that can be produced by a slight variation of the absolute color. Indeed, in the example of a red color for a lipstick, a first red color can subjectively appear cold and lifeless while a second red color, very close in the absolute to the first red color, can subjectively appear warm and rich.

The absolute difference between two colors can be for instance the distance separating these colors in a “standard observer” model, such as the “CIEXYZ” color space, or “CIELAB” color space. These standard observer models are defined by the International Commission on Illumination (abbreviated CIE), and the colors they define are not relative to any particular device such as a computer monitor or a printer, but instead relate to the CIE standard observer which is an averaging of the results of color matching experiments under laboratory conditions.

The RGB “Red Green Blue” color space is defined by coordinates of the red, green, and blue additive primaries, and is typically used in electronics for sensing and displaying colors.

The “CIELAB” color space, also referred to as L*a*b*, expresses colors as three coordinates: L* for lightness, and a* and b* for, respectively, greenish to reddish chromaticity, and blueish to yellowish chromaticity (the chromaticity conveying both hue and chroma measures). In the a*b* plane, a unique hue can be identified by a unique angle in the trigonometric circle. The CIELAB color space is designed to be more perceptually uniform than, for instance, the RGB color space. However, the subjective perception of makeup products colors is not wall translated in the CIELAB color space, such that a slight variation of the absolute color in the CIELAB color space can still produce a great reaction in the subjective perception of the makeup colors.

The human eye perception of colors goes beyond the L*a*b* coordinates, and attaches importance to subjective perceptions such as the “background effect” of a color, where for example looking at a single color square surrounded by a colored background results in different perception of the color square depending on the background's color. Regarding makeup products, the perception of a lipstick color may vary depending on the skin tone of the wearer,

In consequence, there is difficulties in providing a computerized tool for assisting the color experts in the development of colors of makeup products, because of the inconsistencies in the digital transcription of a color, such as the RGB or L*a*b* coordinates, with respect to the subjective perception of the makeup colors.

In addition, another difficulty encountered with computerized tool for assisting the color experts in the development of colors of makeup products, lies in the fact that computer monitors are not equally able to display the same range of colors, and all are anyway limited in the range of colors they can display (used to be called “number of colors”). The resulting problematic is that two different colors, which would have distinguishable properties under human eye perception, may be displayed exactly the same on various monitors, and thus be unusable for an analysis by a makeup color expert.

Thus, the visualizations and comparisons of colors of makeup products are classically still performed with thumbnails color samples of the makeup products, often in a very large number, in laboratory conditions, and are not practicable remotely with a computer, for example in home-office conditions.

Another difficulty in the development of makeup product colors lies in the fact that the applied colors of the product may vary depending on the skin tone of the user wearing the makeup, and the subjective perception of the color may vary depending on the skin tone of the user too. For example, the “background effect” of the skin tone, as mentioned hereinbefore, can change the perception of a makeup product color, and, basically, a light or pale makeup color may turn darker when applied over a dark skin, and a dark and rich makeup color may appear excessively intense when applied over a fair skin, while appearing perfectly matched with a dark skin.

Accordingly, the development of makeup product colors classically needs trying phases on human models to analysis the actual subjective perception when the makeup is worn. These trying phases are typically time-consuming and also expensive.

There is thus a need to provide a tool, in particular a computerized tool, for assisting and saving time to the color experts in the development of colors of makeup products, which would be adapted regarding the subjective perception of the makeup colors, which would not be limited to the performances of a computer monitor, such as “number of colors”, and which would provide the ability to develop makeup colors that are suitable across a variety of skin tones.

According to an aspect of the invention, a computer implemented method for automatically classifying a color of a makeup product, comprises:
providing input coordinates data in the L*a*b* space of a makeup product color;
assigning a color family label (amongst brown, pink, orange, purple, red, for example) to the makeup product color according to an identification of a color family volume, amongst a set of color family volumes in the L*a*b* space, containing the input coordinates data; the color family volumes being designed according to a subjective perception of makeup colors, and the makeup product color being classified according to the assigned labels.

The said subjective perception of makeup colors used for the design of the volumes, and the hereinafter defined boundaries value, line and surface, are advantageously defined by human color experts, for instance according to the aforementioned sensitive subjective perception, specific to makeup colors. Advantageously, the human color experts may provide a visual database of discrete color-points, and the design of the volume and boundaries value, line and surface may be performed to obtain a continuity of color-points by a data-driven computation configured to fit with the visual database. For example, the data-driven computation configured to fit with the visual database can be implemented by a machine-learning trained model.

In other words, the computer-implemented method according to this aspect permits to classify colors based on labels which are representative of the subjective perceptions of makeup colors, and defined by conditions established by the subjective perceptions specific to makeup colors. The consequent classification, for instance applied to each color of a group of analyzed makeup products, can thus provide useful information to a color expert performing development of makeup product colors, despite the limitations of the computer representations of colors (color spaces) and of the on-screen colors display.

According to an embodiment, the set of color family volumes in the L*a*b* space is generated from a data base including a finite number of points in the L*a*b* space, each point being labelled with a respective family label according to the subjective perception of makeup colors, and from a mathematical calculation comprising a triangulation generating envelopes enclosing all the points of each respective family and an interpolation spreading the envelopes until the respective facing surfaces of neighboring envelopes matches with each other, the envelopes defining the enclosure of the respective color family volumes.

According to an embodiment, the color family volumes are configured to delimit brown, pink, orange, purple, and red colors in the L*a*b* space according to the subjective perception of makeup colors.

According to an embodiment, the method additionally comprises:
assigning a lightness subfamily label (amongst light, medium, dark, for example) to the makeup product color according to an identification of the position of the input coordinates data in comparison with at least one lightness boundary value in the lightness coordinate axis L* of the L*a*b* space; the at least one lightness boundary value being designed according to a subjective perception of makeup colors, and the makeup product color being classified according to the assigned labels.

According to an embodiment, the at least one lightness boundary value in the lightness coordinate axis L* of the L*a*b* space is decreased of a step for input coordinates having a chroma value greater than a threshold set according to the subjective perception of makeup colors.

According to an embodiment, the lightness subfamily includes a light label assigned if the lightness input coordinate is greater than a first lightness boundary value, a medium label assigned if the lightness input coordinate is between the first lightness boundary value and a second lightness boundary value, and a dark label assigned if the lightness input coordinate is lower than the second lightness boundary value.

According to an embodiment, the method additionally comprises:
assigning a chroma subfamily label (amongst high, intermediate, low, for example) to the makeup product color according to the position of the input coordinates data in comparison with at least one chroma boundary line in an a*b* plane of the L*a*b* space;
the at least one chroma boundary line being designed according to a subjective perception of makeup colors, and the makeup product color being classified according to the assigned labels.

According to an embodiment, the at least one chroma boundary line in the a*b* plane of the L*a*b* space varies depending on the hue of the input coordinate data, according to the subjective perception of makeup colors.

According to an embodiment, the chroma subfamily includes a high label assigned if the chroma of the input coordinates is greater than a first chroma boundary line, an intermediate label assigned if the chroma of the input coordinates is between the first chroma boundary line and a second chroma boundary line, and a low label assigned if the chroma of the input coordinates is lower than the second chroma boundary line.

According to an embodiment, the method additionally comprises:
assigning a hue tone subfamily label (amongst cool, neutral, warm, for example) to the makeup product color according to the position of the input coordinates data in comparison with at least one hue tone boundary surface inside the respective color family volume in the L*a*b* space;
   the at least one hue tone boundary surface being designed according to a subjective perception of makeup colors, and the makeup product color being classified according to the assigned labels.

According to an embodiment, the at least one hue tone boundary surface in each color family volume of the L*a*b* space is defined according to the subjective perception of makeup colors.

According to an embodiment, the hue tone subfamily includes a warm label assigned if the input coordinates is located on one side of a first hue tone boundary surface, a neutral label assigned if the input coordinates is located between the other side of first hue tone boundary surface and one side of a second hue tone boundary surface, and a cool label assigned if the input coordinates is located on the other side of the second hue tone boundary surface.

According to an embodiment, the makeup product color is classified hierarchically according to the color family label firstly, to the hue tone subfamily label secondly, and then to the lightness subfamily label and the chroma subfamily label.

This hierarchy permits to exhibit a convenient classification of labels for instance for analysis of colors of makeup products. That being said, other hierarchy can be used too, and regarding the processing for assigning of the labels, the respective processing stage can be performed all at the same time or possibly the lightness label should be processed after the chroma label, because the lightness boundary line values may be dependent on chroma label.

According to another aspect, a computer implemented tool, intended to be controlled by a user, for assistance in the development of colors of makeup products, comprises:
a mapping mode adapted for the user to select a group of colors of makeup products from a makeup product color bank, configured to classify each color of the selected group of colors with the method for classifying a color of a makeup product as defined hereinabove, and configured to display a map of the selected colors arranged in a table according to the respectively assigned labels, the table being organized by a major line for each color family labels, and a major column for each hue tone subfamily labels, each major line including a subline for each lightness subfamily labels, each major column including a subcolumn for each chroma subfamily labels.

According to an embodiment, the table is organized by;
five major lines respectively for brown, pink, orange, purple, and red color family labels,
three major columns respectively for cool, neutral, and warm hue tone subfamily labels,
three sublines for each major line respectively for light, medium, and dark lightness subfamily labels, and
three subcolumns for each major column respectively for low, intermediate, and high chroma subfamily labels.

According to an embodiment, the tool additionally comprises:
an application mode adapted for the user to select a set of at least one makeup product color from the displayed map (ID card) and to select at least one skin tone photograph model, configured to display images of simulation of applications of the selected set of makeup product colors respectively on the at least one skin tone photograph model.

According to an embodiment, the tool additionally comprises:
a color creation mode adapted for the user to select at least one skin tone photograph model and to set parameters for generating a custom color, configured to display an image of simulation of an application of the custom color on the at least one skin tone photograph model.

According to an embodiment, the color creation mode is additionally adapted for the user to select a set of at least one makeup product color from the displayed map (ID card), and is configured to simultaneously display comparison images of simulation of applications of the custom color and of the selected set of makeup product colors, respectively on the at least one skin tone photograph model.

According to another aspect, a computer program product comprises instructions which, when the program is executed by a computer, cause the computer to carry out the method as defined hereinabove, or cause the computer to carry out the tool as defined hereinabove.

According to another aspect, a computer-readable storage medium comprises instructions which, when executed by a computer, cause the computer to carry out the method as defined hereinabove, or cause the computer to carry out the tool as defined hereinabove.

In other words, aspects and embodiments provide in particular a digital system that enables instant analysis of color cosmetics shades and shade range creation, based on an integrated process of 1) data visualization of instrumental measurement data according to labels adapted for the classification of makeup products colors; 2) digital application of measured shades on images depicting models of different skin tones taken, for instance using a pseudo-spectral imaging system; 3) functionality to accurately conceive and apply shades digitally on images taken, for example using aforementioned pseudo-spectral camera system.

It is accordingly defined method and system (tool)which allow to integrate the shade range development, that in particular takes into consideration the evaluation of makeup on different skin tones, for makeup product development teams using a digital platform.

This enables product development teams to easily create shade ranges, by providing integrated ability to visualize shades from database of measured shades and digitally conceive new shades, in order to create better-performing, and skin-tone adapted shade ranges for color cosmetics.

In addition, this increases in efficiency the shade ranges development, possibly reducing the shade range development time by about 25% due to ability of visualizing and comparing lipstick shades digitally in dedication classification and on-face simulations.

Moreover, since the aspects and embodiments defined hereinabove provides the ability to develop shade ranges that are deemed suitable across a wide variety of skin tones, this could reduce annual number of shades created, as development teams can visualize and select shades to match specific skin tones from database.

Other advantages and specifications of the invention will appear at the review of the detailed description of embodiments, in no way limiting, and in relation with annexed drawings, amongst which:

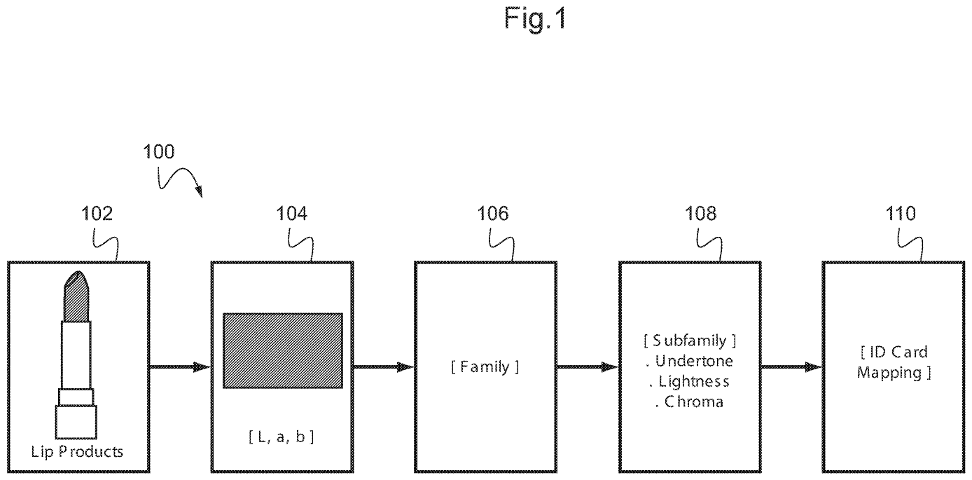

FIG. 1;

[symbol]

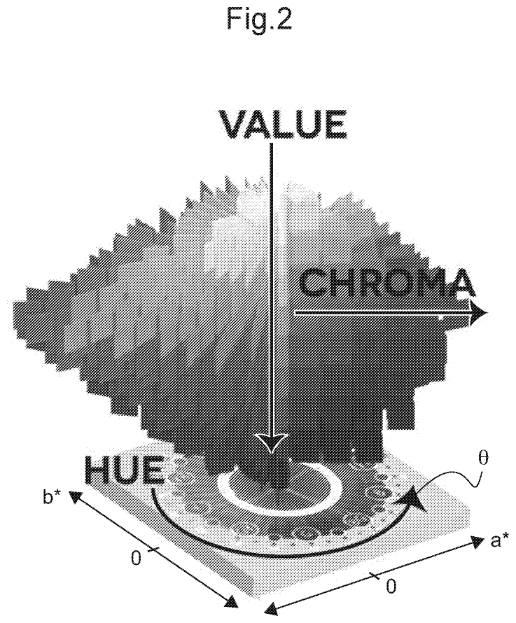

FIG. 2;

[symbol]

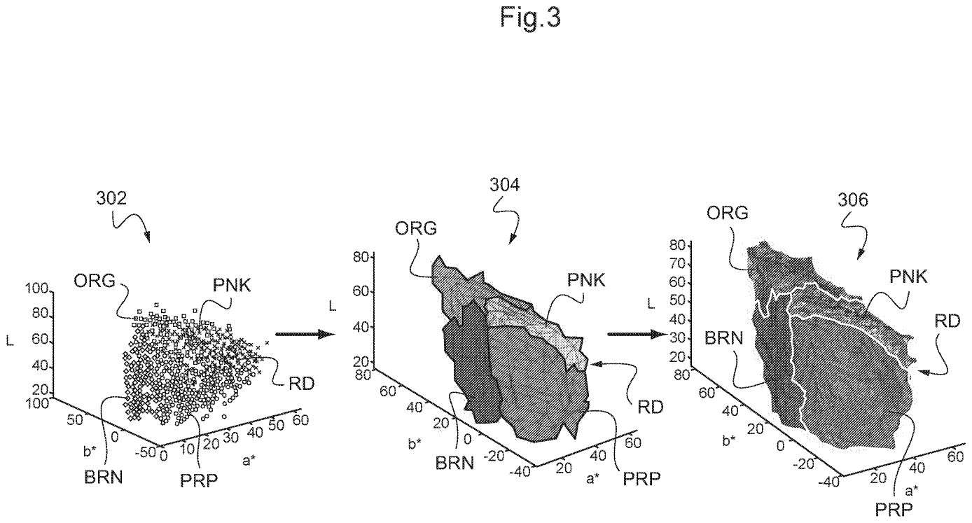

FIG. 3;

[symbol]

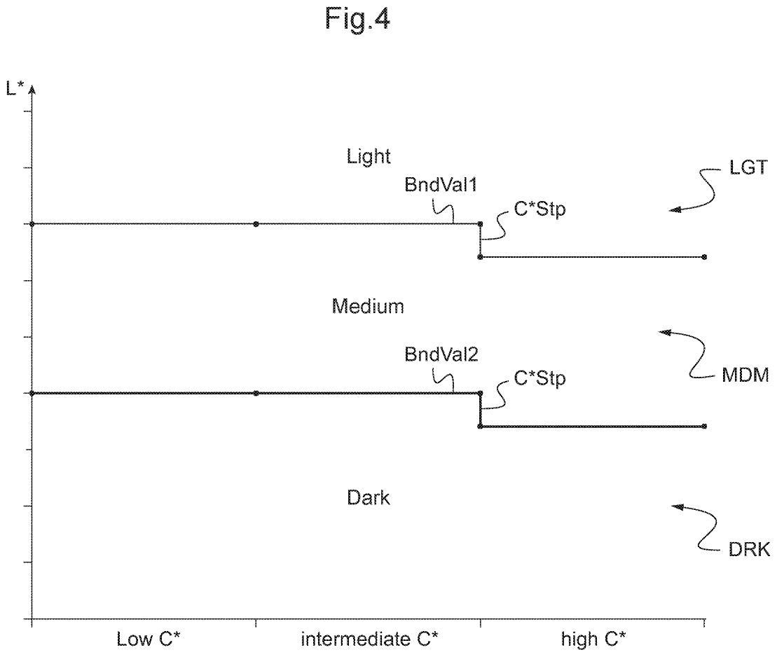

FIG. 4;

[symbol]

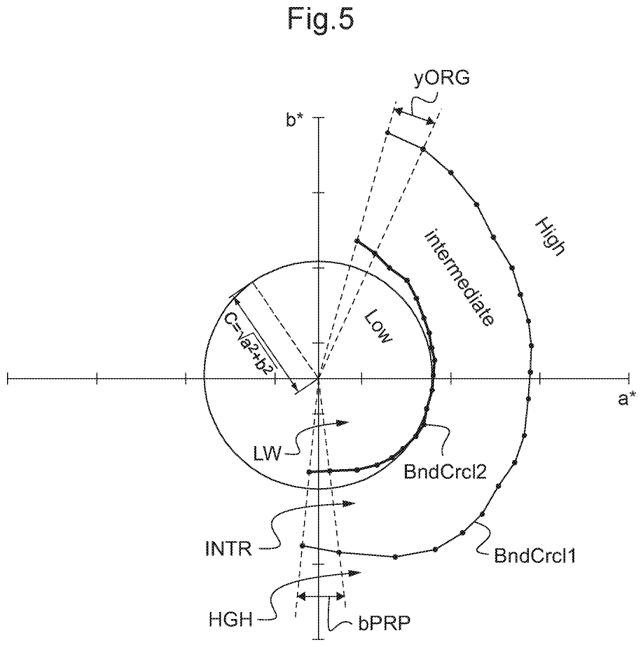

FIG. 5;

[symbol]

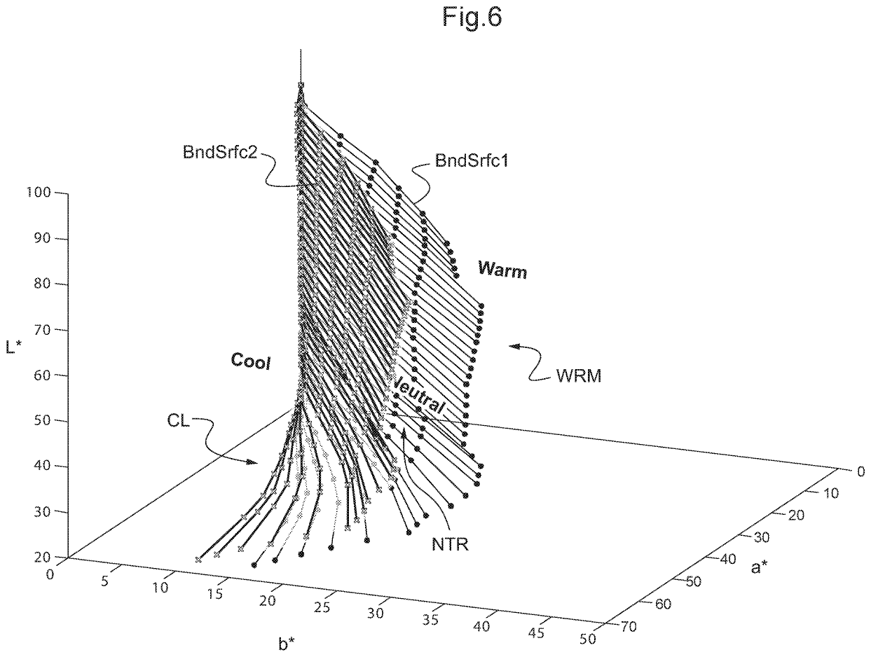

FIG. 6;

[symbol]

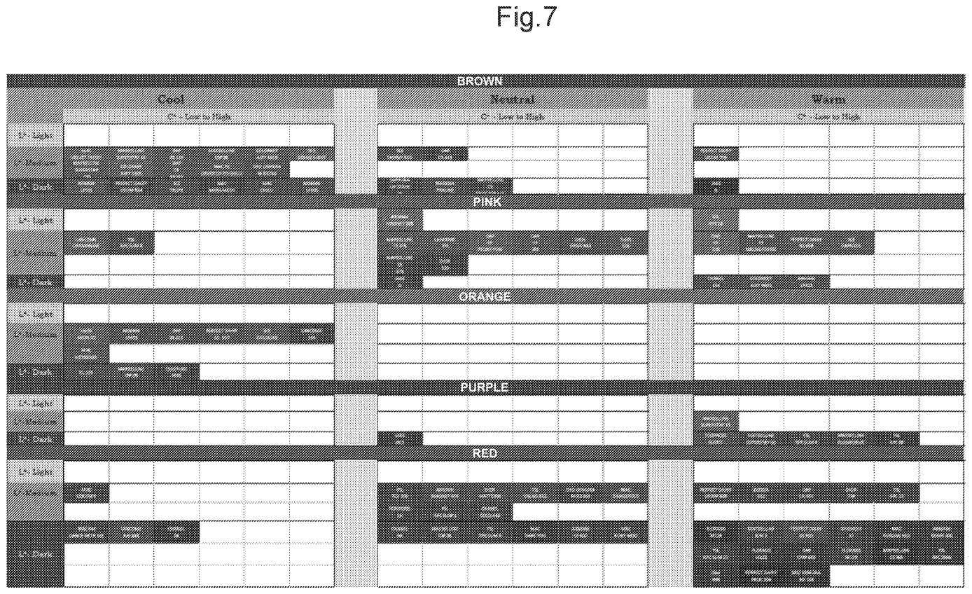

FIG. 7 illustrate embodiments of a method for classifying a color of a makeup product, according to the invention;

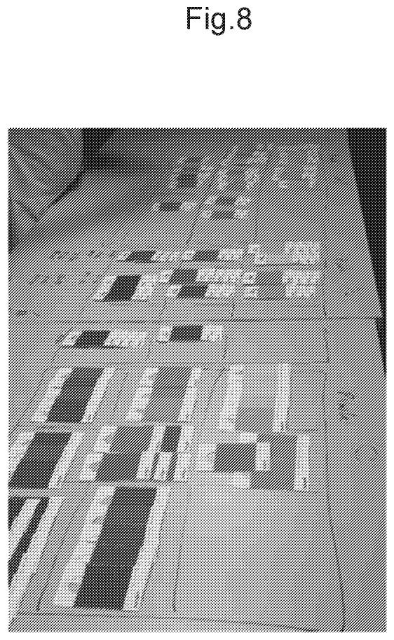

FIG. 8;

[symbol]

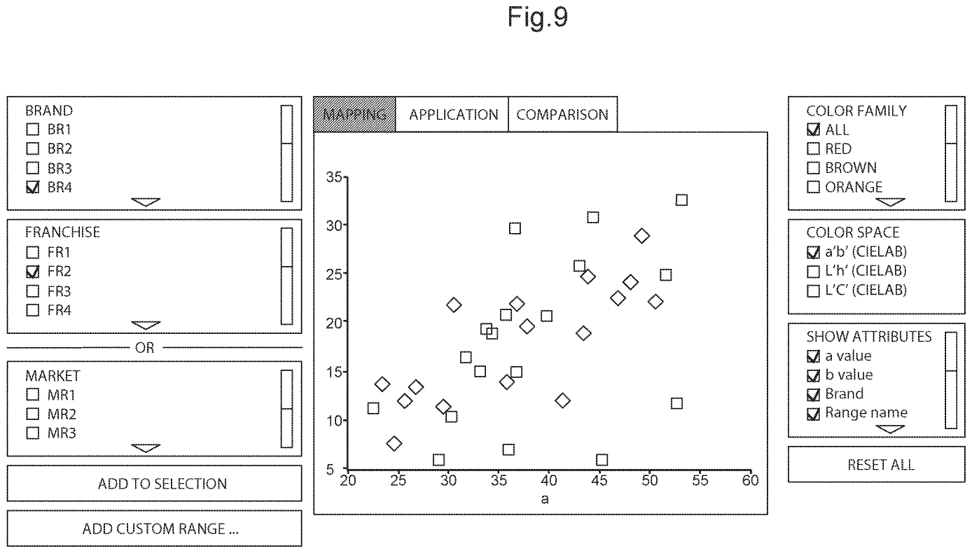

FIG. 9 illustrate difficulties encountered in classical techniques;

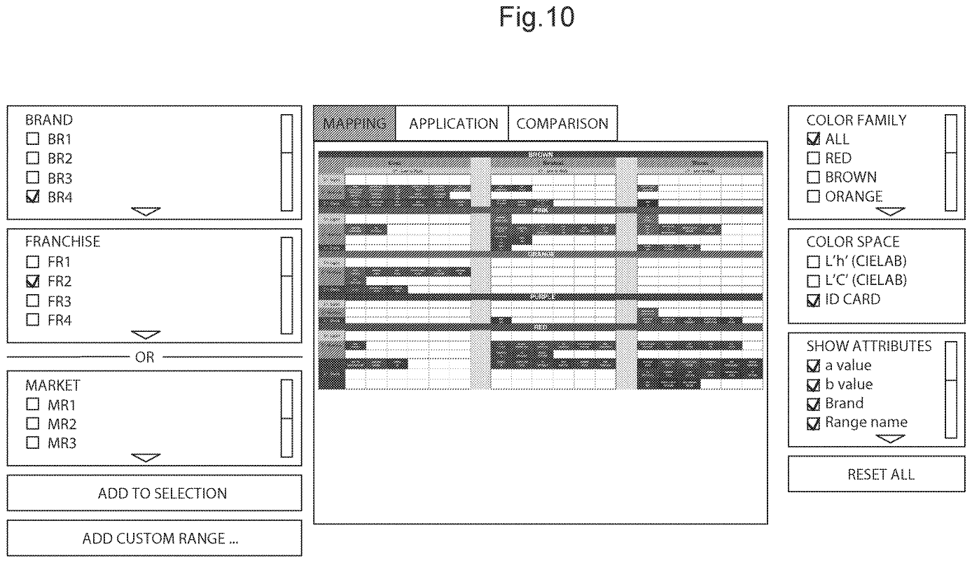

FIG. 10;

[symbol]

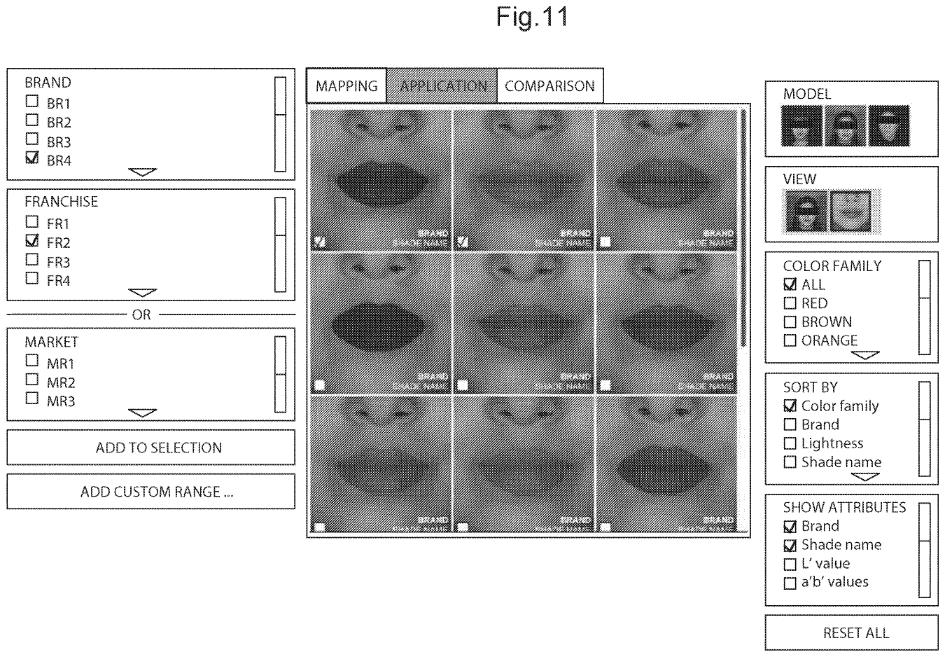

FIG. 11;

[symbol]

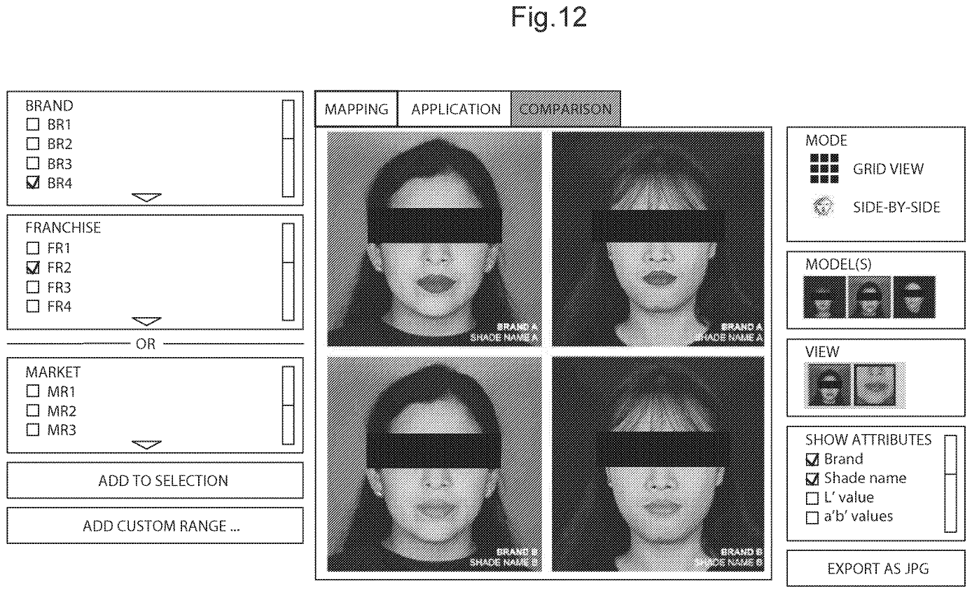

FIG. 12;

[symbol]

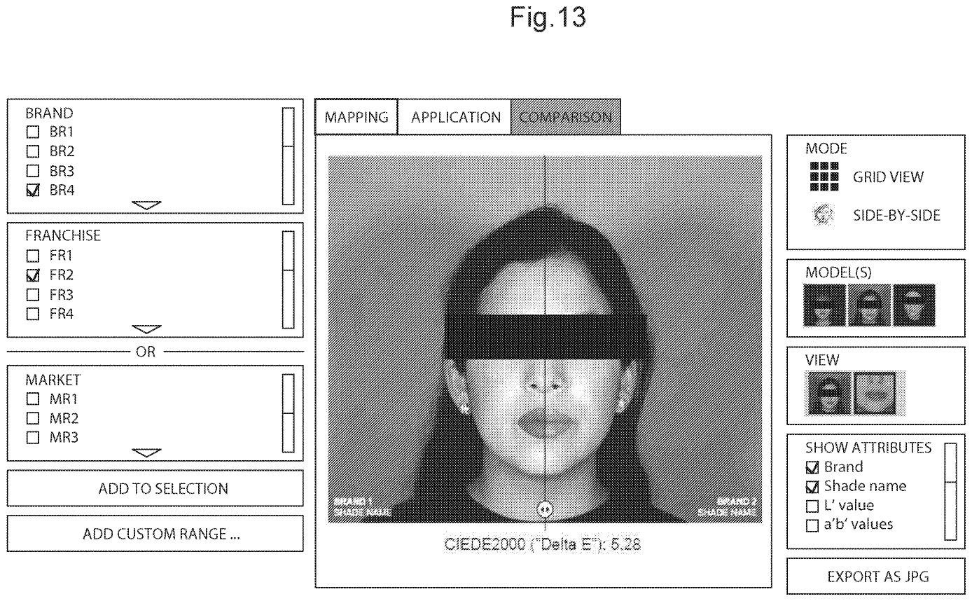

FIG. 13;

[symbol]

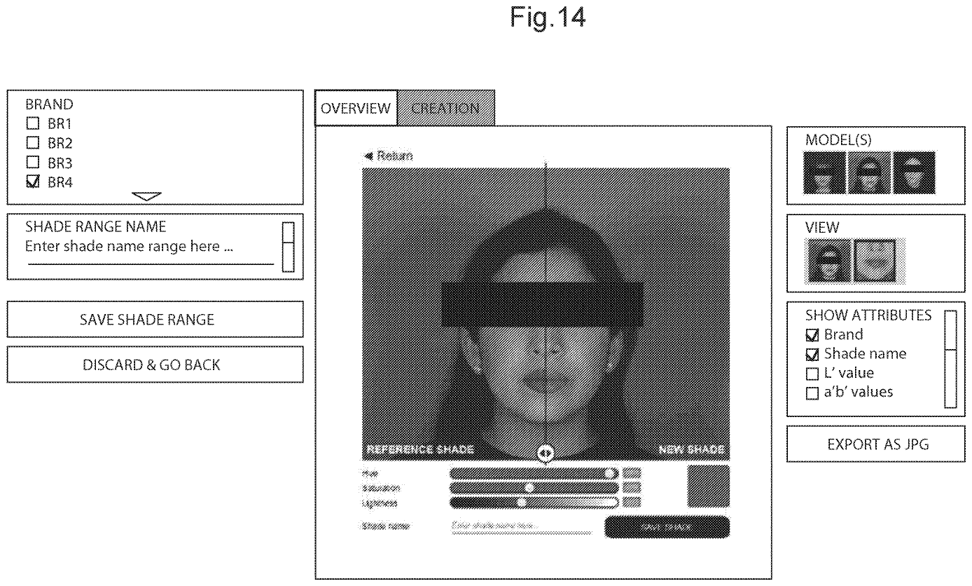

FIG. 14 illustrate embodiments of a tool for assistance in the development of colors of makeup products, according to the invention.

FIG. 1 illustrates a method 100 for classifying a color of a makeup product 102, which is designed to be automatically implemented by a computer, The makeup product 102 is preferentially a lipstick product. The method is described here for providing classification labels for a single color 104, of one single makeup product 102. For instance, the makeup product 102 is selected amongst a database of makeup product colors at a step 102. However, it will be understood that the classification is mostly intended to be applied to several colors of several makeup products, in order to distinguish these colors according to subjective human perception of makeup colors. In such a case the method is performed to each color of the set of several makeup products.

The method comprises, at a step 104, providing input coordinates data in the L*a*b* space of the makeup product color 102. As mentioned hereinabove and as described hereinafter in relation with FIG. 2, the L*a*b* space is the conventional “CIELAB” color space, expressing colors as three coordinates: L* for lightness, and a* and b* for, respectively, greenish to reddish chromaticity, and blueish to yellowish chromaticity (the chromaticity conveying both hue and chroma measures). The step 104 may include a conventional conversion of the color's coordinates from any other color space to coordinate in the L*a*b* color space.

A first assignation step 106 assigns a color family label (which can be for instance brown, pink, orange, purple, or red color families) to the makeup product color 102-104. As disclosed hereinafter in relation with FIG. 3, the color family label may be assigned according to an identification of a color family volume, amongst a set of color family volumes in the L*a*b* space, containing the input coordinates data. In particular, the color family volumes are specifically designed according to a subjective perception of makeup colors. For example, and as described hereinafter in relation with FIG. 3, the color family volumes are decided by fitting with a visual database, advantageously according to a data-driven computation.

Second assignation step 108 assigns a lightness subfamily label (which can be for instance light, medium, or dark lightness subfamilies), a chroma subfamily label (which can be for instance high, intermediate, or low chroma subfamilies), and a hue tone subfamily label(which can be for instance cool, neutral, or warm hue tone subfamilies) to the makeup product color 102-104.

As described hereinafter in relation with FIG. 4, the lightness subfamily label may be assigned according to an identification of the position of the input coordinates data 104 in comparison with at least one lightness boundary value in the lightness coordinate axis L* of the L*a*b* space. In particular, the at least one lightness boundary value is specifically designed according to a subjective perception of makeup colors.

As described hereinafter in relation with FIG. 5, the chroma subfamily label may be assigned according to the position of the input coordinates data 104 in comparison with at least one chroma boundary line in an a*b* plane of the L*a*b* space. In particular, the at least one chroma boundary line is specifically designed according to a subjective perception of makeup colors.

As described hereinafter in relation with FIG. 6, the hue tone subfamily label may be assigned according to the position of the input coordinates data 104 in comparison with at least one hue tone boundary surface inside the respective color family volume 106 in the L*a*b* space. In particular, the at least one hue tone boundary surface is specifically designed according to a subjective perception of makeup colors.

At a final step 110, the makeup product color is classified according to the assigned labels, for instance and advantageously in an identification card map, hierarchically arranged as described hereinafter in relation with FIG. 7.

FIG. 2 illustrates an example discrete representation of the L*a*b* color space, also called CIELAB color space. The CIELAB color space expresses colors as three coordinates: L* for lightness, and a* and b* for, respectively, greenish to reddish hues, and blueish to yellowish hues.

The L*a*b* space permits to easily derive the hue, the chroma and the value of the color points in the L*a*b* coordinate system. The hue of a color point is identified by the trigonometric angle θ in the a*b* plane including the point, and can thus be expressed by θ=tan⁻¹ (b*/a*). The chroma of a color point is defined by the distance from the origin (a*=0; b*=0) in the a*b* plane including the point, and can thus be expressed C*=(a*²+b*²)^{1/2}. The value of a color point is defined by its lightness coordinate L*.

FIG. 3 illustrates the generation of the set of color family volumes in the L*a*b* space, which are used for the identification of the color family label of the input coordinates data at the first assignation step 106 of the method 100.

Firstly, a data base including a finite number of points in the L*a*b* space for each color family is provided, wherein each point is labelled with a respective color family label BRN, ORG, PNK, RD, PRP, as depicted by the scatter plot 302. At this step, the labels are “manually” assigned to each point in the data base, by human color experts and according to the subjective perception of makeup colors. These labels may correspond to the evaluation of a brown color family BRN, an orange color family ORG, a pink color family PNK, a red color family RD, and a purple color family PRP, This “manual” assignation is performed one time for configuring the computer implemented classification method according to the specific subjective perception of makeup colors. This one-time manual assignation may be performed according to a classical technique of classification of makeup colors described hereinafter in relation with FIG. 8.

Secondly, a mathematical calculation is performed in order to extrapolate a continuous volume in the L*a*b* space for each discrete color family scatter plot. As shown by plot 304, the mathematical calculation generates envelopes enclosing all the points of each respective family, for example thanks to a conventional triangulation technique, such as the Delaunay triangulation, and an alpha-shape generation.

Additionally, the mathematical calculation advantageously executes an interpolation spreading the envelopes, as shown by plot 306. The spreading is configured in order to fill the gaps between colors family volumes, until the respective facing surfaces of neighboring envelopes matches with each other. This can for example be performed by choosing the nearest neighbor according to the distance to triangulation surface of each color family.

The envelopes obtained at plot 306, when all the respective facing surfaces of neighboring envelopes matches with each other with no empty gap between them, defines the enclosure of the respective color family volumes.

An input point, positioned in the L*a*b* color space according to its coordinates, is thus assigned with the respective label BRN, ORG, PNK, RD, PRP of the envelope which encloses the input point in the L*a*b* color space.

FIG. 4 illustrates the identification of the position of the input coordinates data 104 in comparison with at least one lightness boundary value BndVal1, BndVal2 used for assigning the lightness subfamily label at step 108 of the method 100.

In this example, the lightness subfamily labels include a “light” lightness label LGT, a “medium” lightness label MDM, and a “dark” lightness label DRK and are identified in comparison with a first lightness boundary value BndVal1 and a second lightness boundary value BndVal2, inferior than the first lightness boundary value BndVal1. The light label LGT is assigned if the lightness input coordinate L* is greater than the first lightness boundary value BndVal1, the medium label MDM is assigned if the lightness input coordinate L*is between the first lightness boundary BndVal1 value and the second lightness boundary value BndVal2, and the dark label DRK is assigned if the lightness input coordinate L* is lower than the second lightness boundary value BndVal2.

Here again, the both lightness boundary values BndVal1, BndVal2 are specifically designed according to the subjective perception of makeup colors, and in particular, the level in the L* axis of the lightness boundary values may be set according to the chroma of the input coordinate data.

In addition, the lightness boundary values BndVal1, BndVal2 are advantageously decreased of a step C*Stp for input coordinates having a chroma value C* greater than a threshold chosen according to the subjective perception of makeup colors. Indeed, the lightness boundary values BndVal1, BndVal2 slightly decrease for the highest chromatic colors, in particular, for the “high” chroma subfamilly label assigned at step 108 of the method 100 described in relation with FIG. 5. This advantageously permits to compensate for an effect, called Helmholtz Kohlrausch effect, where the subjective perception of brightness increases with chroma.

FIG. 5 illustrates the identification of the position of the input coordinates data 104 in comparison with at least one chroma boundary line BndCrel1, BndCrcl2 in the a*b* plane including the input coordinates point, used for assigning the chroma subfamily label at step 108 of the method 100.

In this example, the chroma subfamily labels include a “high” chroma label HGH, an “intermediate” chroma label INTR, and a “low” chroma label LW and are identified in comparison with a first chroma boundary line BndCrel1 and a second chroma boundary line BndCrcl2, inferior than the first chroma boundary line BndCrcl1. In any a*b* plane, the chroma level C* is defined by the Euclidian distance of the point from the origin (0; 0), i.e. C=\sqrt{a²+b²}, or C*=(a*²+b=²)1/2. Accordingly, the first chroma boundary line BndCrel1 and the second chroma boundary line BndCrcl2 are circle-like, i.e. these lines have a circular appearance.

The high label HGH is assigned if the chroma of the input coordinate C* is greater than the first chroma boundary line BndCrel1, the intermediate label INTR is assigned if the chroma of the input coordinate C* is between the first chroma boundary line BndCrel1 and the second chroma boundary line BndCrcl2, and the low label LW is assigned if the chroma of the input coordinate C* is smaller than the second chroma boundary line BndCrcl2.

Here again, the both chroma boundary lines BndCrel1, BndCrcl2 are specifically designed according to the subjective perception of makeup colors, and in particular, these lines are defined only for hues in the a*b* plane that are susceptible to an application of a makeup product. In the example of lipstick makeup products, the hues that are susceptible to an application are approximatively located on the half plane of positive value on a*, i.e. from yellowish orange hues yORG to blueish purple hues bPRP.

In addition, the chroma boundary lines BndCrcl1, BndCrcl2 are advantageously depending on the hue of the input coordinate data, in order to take into account to the subjective perception of the chroma in accordance with the hue of the respective color. Indeed, for example the orange hues yORG appear “weaker” in terms of chroma, than the purple hues bPRP. In consequences, the both chroma boundary lines BndCrel1, BndCrcl2 may have the appearance of a portion of a spiral having a slightly larger radius on the positive values of b* side (yellowish orange hues yORG) and a slightly narrower radius on the negative values of b* side (blueish purple hues bPRP), in comparison with the spiral radius around the zero value of b* (reddish hues at positive values of a*).

FIG. 6 illustrates the identification of the position of the input coordinates data 104 in comparison with at least one hue tone boundary surface BndSrfc1, BndSrfc2 in the L*a*b* space, more particularly in the color family volume (FIG. 3) including the input coordinates point, used for assigning the hue tone subfamily label at step 108 of the method 100.

In this example, the hue tone subfamily labels include a “warm” hue tone label WRM, a “neutral” hue tone label NTR, and a “cool” hue tone label CL and are identified in comparison with a first hue tone boundary surface BndSrfc1 and a second hue tone boundary surface BndSrfc2, delimiting the space inside each respective color family volumes BRN, ORG, RD, PNK, PRP.

The warm label WRM is assigned if the input point is located on one side of the first hue tone boundary surface BndSrfc1, the neutral label NTR is assigned if the input point is located between the other side of the first hue tone boundary surface BndSrfc1 and one side of the second hue tone boundary surface BndSrfc2, and the cool label CL is assigned if the input point is located on the other side of the second hue tone boundary surface BndSrfc2.

Here again, the both hue tone boundary surfaces BndSrfc1, BndSrfc2 are specifically designed according to the subjective perception of makeup colors, and in particular, these surfaces'location and the neutral range are decided by visual results of makeup color experts. The hue tone boundary surfaces BndSrfc1, BndSrfc2 are defined along lightness(for instance from L*=20 to 90) and chroma (for instance from C*=0 to max level) simultaneously, and their coordinate definition may be registered in a look-up table for performing the identification of the relative position of the input coordinate data.

FIG. 7 illustrates an example result at the final step 110 of the classification method 100 described hereinabove in relation with FIGS. 1 to 6.

At the final step 110, the makeup product color is classified according to the assigned labels, advantageously in the illustrated identification card map, which depicts a hierarchical arrangement of colors according to the color family labels firstly, to the hue tone subfamily labels secondly, and then equally to the lightness subfamily label and the chroma subfamily label.

In the illustrated identification card map, a plurality of colors of makeup products are classified together, each color having been processed by the method described hereinabove in relation with FIGS. 1 to 6, for the assignation of the respective labels which defines the position of the color in the identification card map.

In the identification card map, the colors are accordingly arranged in a table organized by a major line for each color family labels “brown”, “pink”, “orange”, “purple”, and “red”, and a major column for each hue tone subfamily labels “cool”, “neutral”, and “warm”. In addition, each major line includes a set of sublines for the respective lightness subfamily labels “light”, “medium” and “dark”, and each major column includes a set of subcolumns for the respective chroma subfamily labels “low”, “intermediate” and “high”.

Alternatively, the table may be organized without the sets of subcolumns for each chroma subfamily labels, replaced by a sorting of the colors in each lightness sublines by the rising order of their chroma values, for instance rising order from left to right in the respective sublines.

Since the colors are positioned according to their labels in this identification card map, i.e. according to the subjective perceptions they cause as a makeup product, a color expert can perform an improved analysis of the classified group of makeup colors.

Indeed, firstly, since the classification is automatically performed by a computer, the identification card map can be generated many times, for different selections of groups of colors of makeup products, in a very fast manner.

The method thus permits to save a lot of time to colors expert, in comparison with the classical technique for this kind of classification, performed manually by visual inspection of thumbnail color samples as shown by FIG. 8.

Secondly, thanks to the position of the colors corresponding to the subjective perceptions they cause as a makeup product, the identification card map is not limited by the color displaying performances of a given computer monitor. Indeed, a computer monitor may display the same color for two different data, for example a low chroma warm pink may be displayed identical as a low chroma cool brown on the computer monitor because of its limited performance in terms of “number of colors” compared to the sensitivity of human eye perception. Such a situation, without the classification in the identification card map, results to an erroneous analysis of these colors. However, the positions of the two colors in the identification card map provides the information of their practical differences to a color expert, despite these two colors being displayed by the same signal on the computer monitor.

FIG. 8 is a photograph of the classical technique for classifying colors of makeup products, for instance in order to compare products of different brands and franchise of a same holding, or between owned legacy products and a competitor's products.

The classification is classically made by color experts with physical samples of the colors under human eye perception, for instance with thumbnails color samples of the makeup products which are individually characterized according to the subjective perception, and are spread out over a lab bench or a white board.

This classical technique is obviously time-consuming and is not adapted, or even impossible, to be performed many times for many different groups of makeup colors; while, as mentioned hereinabove, the identification card map can be generated as many times as wanted, instantly and effortlessly.

FIG. 9 illustrates an example of a classical computer representation of a group of colors, here in a plot projected on the a*b*2-dimensionnal plane (i.e. by ignoring the L* coordinate). Even if the CIELAB a*b* plane has been designed to provide a close representation of human perception of colors, such a representation is unusable for analyzing makeup colors. Indeed, even if identifying the color families “brown”, “orange”, “pink”, “red”, “purple” may be partially visually performed by a color expert on such a plot, other characterizations are limited to the performance of color displaying of the computer screen.

The aforementioned problem where a same color signal is displayed on the computer monitor for two different color data (for example a low chroma warm pink may identically displayed as a low chroma cool brown)remains and the classification according to subjective perception of makeup colors is not practicable.

On another point of view, while the chroma value may be seen as the distance of the color point from the origin, the subjective perception of chroma varies depending on the hue. In consequence, a high chroma point in a given hue (for instance a purplish hue), may contradictory be plotted closer to the origin than a lower chroma point in another hue (for instance an orangish hue), so that the colors points may appear mixed and disorganized in the a*b* plot. The classification according to subjective perception of makeup colors remains to be performed visually, and is thus not practicable because of limitation of the displaying performance of the computer monitor.

FIG. 10 illustrates a complete computer tool for assisting a color expert, i.e. a “user”, in the development of colors of makeup products, benefiting from the classification method and identification card map described hereinabove in relation with FIGS. 1 to 7.

The tool, which is implemented by a computer controlled by the user, may be embodied in practice as a computer program product comprising instructions which, when the program is executed by a computer, cause the computer to carry out the tool according to the present disclosure; or may be embodied in practice as a computer-readable storage medium comprising instructions which, when executed by a computer, cause the computer to carry out the tool according to the present disclosure.

The tool firstly comprises a mapping mode configured to provide the identification card map as described hereinabove in relation with FIG. 7, for a selected group of makeup colors.

The user is accordingly able to select a group of colors of makeup products from a makeup product color bank, such as for example a bank including the makeup colors of in-house brands and franchises, and/or makeup colors of competitor's brands and franchises, to be displayed in mapping mode.

The user may also select the markets to which the makeup products are destinated, or many other options depending on the business sectorization of the color bank.

In the example of FIG. 7, the identification card map thus classifies the selected group of colors in the table is organized by five major lines respectively for brown, pink, orange, purple, and red color family labels; by three major columns respectively for cool, neutral, and warm hue tone subfamily labels; by three sublines for each major line respectively for light, medium, and dark lightness subfamily labels; and by three subcolumns for each major column respectively for low, intermediate, and high chroma subfamily labels.

Accordingly, the mapping mode of the tool provides to the user data visualization of instrumental measurement data in the table arranged according to subjective perception of makeup colors. The mapping permits to the user to select shades to visualize in this meaningful identification card map, for example a successful competitor shade range compared to an in-house shade range, to understand white spaces that the in-house brand currently does not cover with shades.

FIGS. 11, 12 and 13 illustrates an application mode of the tool, adapted to digitally simulate on-face visualization of applied shade range, for more specific considerations of the makeup colors selected by the user.

The application mode is adapted for the user to select a set of one or more makeup product color from the displayed identification card map from the mapping mode, and to select one skin tone photograph model or several skin tone photograph models. The application mode is configured to display images of simulation of applications of the selected set of makeup product colors respectively on the at least one skin tone photograph model.

Advantageously, the simulation of applications of the selected set of makeup product colors respectively on the at least one skin tone photograph model is performed by the pseudo-spectral imaging system disclosed in the scientific publication “Liu Z., Xiao K., Pointer M. et al., “Developing a multi-spectral imaging system using a RGB camera under two illuminations” In: Proceedings of the 28th IS&T Color and Imaging conference. 28th Color and Imaging Conference, 4-19 Nov. 2020, Online. Society for Imaging Science and Technology”; or by the technique disclosed in the United State of American granted patent document n° U.S. Pat. No. 8,498,456 B2 (entitled “Method and system for applying cosmetic and/or accessoral enhancements to digital images”); or by the technique disclosed in the United State of American patent application document n° US2018/0075524A1 (“Applying virtual makeup products”).

FIG. 11 shows possible options in the application mode. In this example, the user selected about nine or more shades from the mapping mode, and the user selected one skin tone photograph model.

The images of simulation of applications of the selected set of makeup product shades on the selected skin tone photograph model are displayed in a grid which adapts dynamically to the selection. In this example the grid is 3×3 images and is scrollable upward and downward to browse the grid.

Two view options may be provided for displaying the images of simulations, for instance a full-face view (see FIG. 12) or a close-up view as depicted in FIG. 11.

Shade selection can be modified at any time, by the same process as in mapping mode, for instance using checkable boxes for each image of simulation. Also, the shade selection that is modified can automatically be reflected in the mapping mode.

FIG. 12 shows other possible options in the application mode. In this example, the user selected two shades from the mapping mode or previous application mode, for instance from the application mode example of FIG. 11, and the user selected two skin tone photograph models.

FIG. 13 shows other possible options in the application mode. In this example, the user selected two shades from the mapping mode or previous application mode, for instance from the application mode example of FIG. 11, and the user selected one skin tone photograph model. When only two shades are selected, the application mode provides side-by-side comparison mode, where dragging a cursor to the left and to the right permits to instantly compare the two shades.

FIG. 14 illustrates a color creation mode of the tool, adapted to digitally create a new shade, and simulate on-face visualization of the shade in creation, as a preliminary design step for creating a new makeup product.

The color creation mode is adapted for the user to select at least one skin tone photograph model and to set parameters for generating a custom color. The color creation mode is configured to display, in real time, an image of simulation of an application of the custom color on the at least one skin tone photograph model.

For example, the parameters generating the custom color may include a hue parameter, a saturation parameter and lightness parameter. Finish parameters such as “matt”, “satin” or “shine” may also be provided.

In addition, the color creation mode is advantageously adapted for the user to select one existing makeup product color from the displayed identification card map, and configured to simultaneously display comparison images of simulation of applications of the custom color and of the selected set of makeup product colors, respectively on the at least one skin tone photograph model. For example, the simultaneous display of the comparison images may be embodied with a drag cursor as depicted by FIG. 13 or by a grid of simulated images as depicted by FIG. 11 or 12.

For instance, the user may compare the two shades, by looking at the two shades digitally applied on face in a side-by-sideview, and additionally with indications of color differences A(E), L*, C*, h(θ).

In resume, the tool described hereinabove in relation with FIGS. 10 to 14 provides a digital system that enables instant analysis of color cosmetics shades and shade range creation, based on an integrated process interacted by a user according to:
1) a data visualization representative of the specific subjective perception of makeup colors, which allows the user to selects shades to visualize and perform meaningful analysis of products and markets.
2) a digital application of measured shades on images depicting models of different skin tones taken using a pseudo-spectral imaging system, which allows the user to evaluate the shades visually on models of different skin type by applying shades (e.g. lipstick shades) digitally on images showing the face of models with different skin tone, to understand fit to market.
3) a functionality to accurately conceive and apply shades digitally on images taken using aforementioned pseudo-spectral simulation imaging system, which allows the user to digitally create shade using an input of lightness, chroma, hue and makeup finish values, that will be rendered in real-time on the image of a model's face.

1. Computer implemented method (100) for automatically classifying a color of a makeup product (102), comprising:
providing input coordinates data in the L*a*b* space (104) of a makeup product color;
assigning a color family label (106) to the makeup product color according to an identification of a color family volume, amongst a set of color family volumes in the L*a*b* space (ORG, PNK, RD, PRP, BRN), containing the input coordinates data;
the color family volumes (ORG, PNK, RD, PRP, BRN) being designed according to a subjective perception of makeup colors, and the makeup product color being classified according to the assigned labels.

2. Method according to claim 1, wherein the set of color family volumes in the L*a*b* space (ORG, PNK, RD, PRP, BRN )is generated from a data base (302) including a finite number of points in the L*a*b* space, each point being labelled with a respective family label according to the subjective perception of makeup colors, and from a mathematical calculation comprising a triangulation (304) generating envelopes enclosing all the points of each respective family and an interpolation (306) spreading the envelopes until the respective facing surfaces of neighboring envelopes matches with each other, the envelopes defining the enclosure of the respective color family volumes.

3. Method according to claim 1, wherein the color family volumes (BRN, PNK, ORG, PRP, RD) are configured to delimit brown, pink, orange, purple, and red colors in the L*a*b* space according to the subjective perception of makeup colors.

4. Method according to claim 1, additionally comprising:
assigning a lightness subfamily label (108) to the makeup product color according to an identification of the position of the input coordinates data in comparison with at least one lightness boundary value (BndVal1, BndVal2) in the lightness coordinate axis L* of the L*a*b* space;
the at least one lightness boundary value (BndVal1, BndVal2) being designed according to a subjective perception of makeup colors, and the makeup product color being classified according to the assigned labels.

5. Method according to claim 4, wherein the at least one lightness boundary value (BndVal1, BndVal2) in the lightness coordinate axis L* of the L*a*b* space is decreased of a step (C*Stp) for input coordinates having a chroma value greater than a threshold set according to the subjective perception of makeup colors.

6. Method according to claim 4, wherein the lightness subfamily includes a light label (LGT) assigned if the lightness input coordinate is greater than a first lightness boundary value (BndVal1), a medium label (MDM) assigned if the lightness input coordinate is between the first lightness boundary value (BndVal1) and a second lightness boundary value (BndVal2), and a dark label (DRK) assigned if the lightness input coordinate is lower than the second lightness boundary value (BndVal2).

7. Method according to claim 1, additionally comprising:
-assigning a chroma subfamily label (108) to the makeup product color according to the position of the input coordinates data in comparison with at least one chroma boundary line (BndCrcl1, BndCrcl2) in an a*b* plane of the L*a*b* space;
the at least one chroma boundary line (BndCrcl1, BndCrcl2) being designed according to a subjective perception of makeup colors, and the makeup product color being classified according to the assigned labels.

8. Method according to claim 7, wherein the at least one chroma boundary line (BndCrcl1, BndCrcl2) in the a*b* plane of the L*a*b* space varies depending on the hue of the input coordinate data, according to the subjective perception of makeup colors.

9. Method according to claim 7, wherein the chroma subfamily includes a high label (HGH) assigned if the chroma of the input coordinates is greater than a first chroma boundary line (BndCrcl1), an intermediate label (INTR) assigned if the chroma of the input coordinates is between the first chroma boundary line (BndCrcl1) and a second chroma boundary line (BndCrcl2), and a low label (LW) assigned if the chroma of the input coordinates is lower than the second chroma boundary line (BndCrcl2).

10. Method according to claim 1, additionally comprising:
assigning a hue tone subfamily label (108) to the makeup product color according to the position of the input coordinates data in comparison with at least one hue tone boundary surface (BndSrfc1, BndSrfc2) inside the respective color family volume in the L*a*b* space;
the at least one hue tone boundary surface (BndSrfc1, BndSrfc2) being designed according to a subjective perception of makeup colors, and the makeup product color being classified according to the assigned labels.

11. Method according to claim 10, wherein the at least one hue tone boundary surface (BndSrfc1, BndSrfc2) in each color family volume of the L*a*b* space is defined according to the subjective perception of makeup colors.

12. Method according to claim 10, wherein the hue tone subfamily includes a warm label (WRM) assigned if the input coordinates is located on one side of a first hue tone boundary surface (BndSrfc1), a neutral label (NTR) assigned if the input coordinates is located between the other side of first hue tone boundary surface (BndSrfc1) and one side of a second hue tone boundary surface (BndSrfc2), and a cool label (CL) assigned if the input coordinates is located on the other side of the second hue tone boundary surface (BndSrfc2).

13. Method according to claim 1, wherein the makeup product color is classified hierarchically according to the color family label firstly, to the hue tone subfamily label secondly, and then to the lightness subfamily label and the chroma subfamily label.

14. Computer implemented tool, intended to be controlled by a user, for assistance in the development of colors of makeup products, comprising:
a mapping mode (FIG. 10) adapted for the user to select a group of colors of makeup products from a makeup product color bank, configured to classify each color of the selected group of colors with the method for classifying a color of a makeup product according to claim 1, and configured to display a map of the selected colors arranged in a table according to the respectively assigned labels, the table being organized by a major line for each color family labels, and possibly a major column for each hue tone subfamily labels, each major line possibly including a subline for each lightness subfamily labels, each major column possibly including a subcolumn for each chroma subfamily labels.

15. Tool according to claim 14, wherein the method for classifying a color of a makeup product is according to the table being organized by:
five major lines respectively for brown, pink, orange, purple, and red color family labels,
three major columns respectively for cool, neutral, and warm hue tone subfamily labels,
three sublines for each major line respectively for light, medium, and dark lightness subfamily labels, and
three subcolumns for each major column respectively for low, intermediate, and high chroma subfamily labels.

16. Tool according to claim 14, additionally comprising:
an application mode adapted for the user to select a set of at least one makeup product color from the displayed map (ID card) and to select at least one skin tone photograph model, configured to display images of simulation of applications of the selected set of makeup product colors respectively on the at least one skin tone photograph model.

17. Tool according to claim 14, additionally comprising:
a color creation mode adapted for the user to select at least one skin tone photograph model and to set parameters for generating a custom color, configured to display an image of simulation of an application of the custom color on the at least one skin tone photograph model.

18. Tool according to claim 17, wherein the color creation mode is additionally adapted for the user to select a set of at least one makeup product color from the displayed map, and is configured to simultaneously display comparison images of simulation of applications of the custom color and of the selected set of makeup product colors, respectively on the at least one skin tone photograph model.

19. Computer program product comprising instructions which, when the program is executed by a computer, cause the computer to carry out the method according to claim 1, or cause the computer to carry out the tool.

20. Computer-readable storage medium comprising instructions which, when executed by a computer, cause the computer to carry out the method according to claim 1, or cause the computer to carry out the tool.
